(19) United States
(12) Patent Application Publication
(10) Pub. No.: US 2008/0128061 A1
(43) Pub. Date: Jun. 5, 2008

(54) Pneumatic tire with spiral grooving

(76) Inventors: Aaron Scott Puhala, Kent, OH (US); David Charles Poling, Uniontown, OH (US); Paul Bryan Maxwell, Kent, OH (US); Robert Bernard Nelson, Wadsworth, OH (US)

Correspondence Address: The Goodyear Tire & Rubber Company;Patent & Trademark Department - D/823, 1144 East Market Street, Akron, OH, 44316-0001, US

(21) Appl. No.: 11/633,695

(22) Filed: Dec. 4, 2006

(51) Int. Cl. B60C 11/03

(52) U.S. Cl. 152/209.8; 152/209.1

(57) ABSTRACT

The pneumatic tire tread has a radially outermost surface defining a circumferential length of the tire and the tread has at least one circumferentially extending groove. The groove has a spiral configuration across the tread surface and a pair of laterally spaced terminal ends. The circumferential length of the spiral groove, as measured between the terminal ends of the groove, is greater than 50% of the circumferential length of the tire. The spiral groove creates a spiral rib or projecting tread element row that moves across the tread width.

### FIELD OF THE INVENTION

The present invention is directed to a pneumatic tire. More specifically, the present invention is directed to a pneumatic tire and tread wherein the tread has at least one circumferentially extending spiral groove.

### BACKGROUND OF THE INVENTION

In a conventional pneumatic tire, particularly a high-performance tire, the tread pattern is generally formed by combining circumferential grooves extending along the circumferential direction of the tire with a plurality of grooves inclined relative to the circumferential direction. The combination of grooves forms a plurality of tread blocks along the radially outer surface of tire. If the inclined grooves do not extend completely across the equatorial plane of the tire, a central rib may be formed in the tread.

The grooves, and the resulting tread elements formed, partially determine the performance characteristics of the tire. It is a goal of the present invention to achieve a tire with excellent wet tire performance and good traction characteristics.

### SUMMARY OF THE INVENTION

The present invention is directed to a pneumatic tire having improved wet drive characteristics wherein the tread is provided with grooves designed to assist in moving water away from the center of the tire tread. The pneumatic tire tread has a radially outermost surface defining a circumferential length of the tire and the tread has at least one circumferentially extending groove. The groove has a spiral configuration across the tread surface and a pair of laterally spaced terminal ends. The circumferential length of the spiral groove, as measured between the terminal ends of the groove, is greater than 50% of the circumferential length of the tire. The spiral groove creates a spiral rib or projecting tread element row that moves across the tread width.

The tire has at least one spiral groove and may be part of an asymmetrical or directional tire tread. The tire preferably has not more than ten such spiral grooves and can have as few as only one groove. The spiral groove may be located in only one tread half or may cross the equatorial plane.

In one aspect of the invention, the spiral groove is inclined at an angle of not more than 30° relative to the equatorial plane of the tire.

In another aspect of the invention, the width of the at least one spiral groove varies along the length of the groove.

In additional aspects of the invention, the length of the at least one spiral groove between the terminal ends is greater than 75% of the circumferential length of the tire. Alternatively, the length of the spiral groove between the terminal ends is greater than the circumferential length of the tire.

### BRIEF DESCRIPTION OF THE DRAWINGS

The invention will be described by way of example and with reference to the accompanying drawings in which:

FIG. 1A illustrates a pneumatic tire;

FIG. 1B is a flat rendering of the tread of FIG. 1;

FIG. 2 illustrates a second tire embodiment employing the spiral groove;

FIG. 2B is a flat rendering of the tread of FIG. 2;

FIG. 3 illustrates a third tire embodiment employing the spiral groove;

FIG. 3B is a flat rendering of the tread of FIG. 3; and

FIG. 4 is a fourth embodiment of a tire tread.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

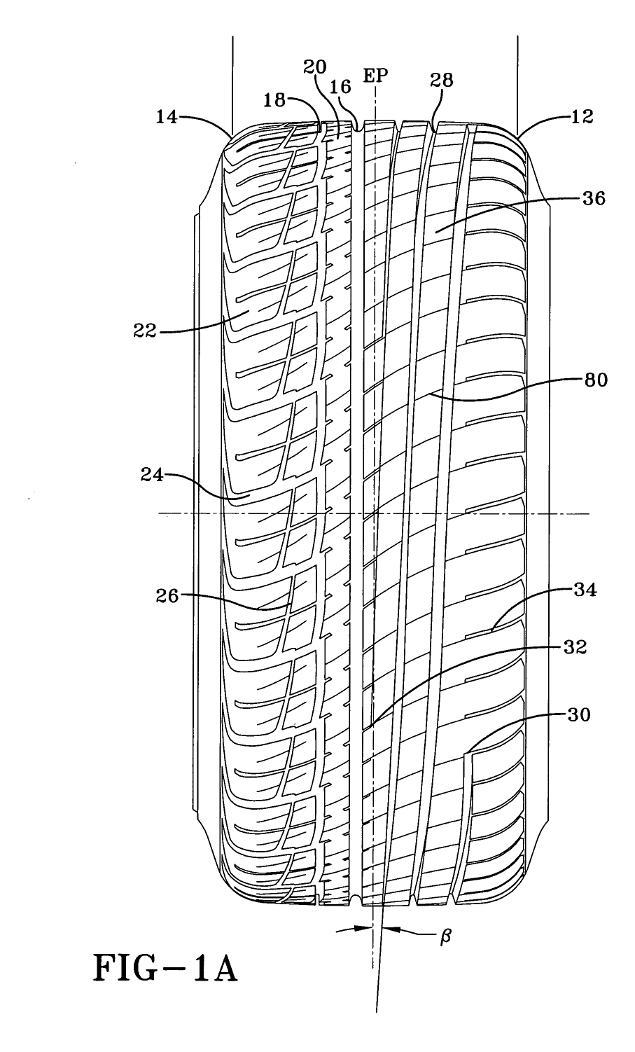

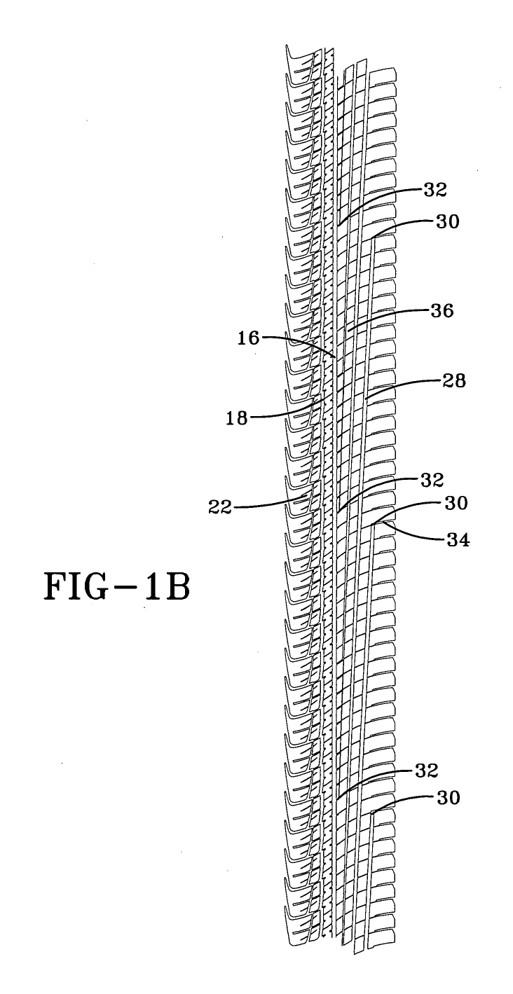

FIG. 1A illustrates a pneumatic tire and FIG. 1B is a flat view of the tire tread of FIG. 1A. The tire has a tread defined between a pair of opposing tread edges 12, 14. Located at a mid-point between the tread edges 12, 14, and along a mid-point of the tire, is the tire equatorial plane EP that divides the tread into a pair of adjacent tread halves.

In the first tread half are two continuous circumferentially extending grooves 16, 18. A continuous rib 20 is located between the pair of circumferentially extending grooves 16, 18. Axially outward of the continuous rib 20 is a shoulder region located between one of the circumferential grooves and the tread edge. The shoulder region has a plurality of tread blocks 22 created by lateral grooves 24 extending between the adjacent circumferential groove 18 and the tread edge 14. In the illustrated shoulder region, the shoulder tread blocks 22 are further divided by short length circumferential grooves 26.

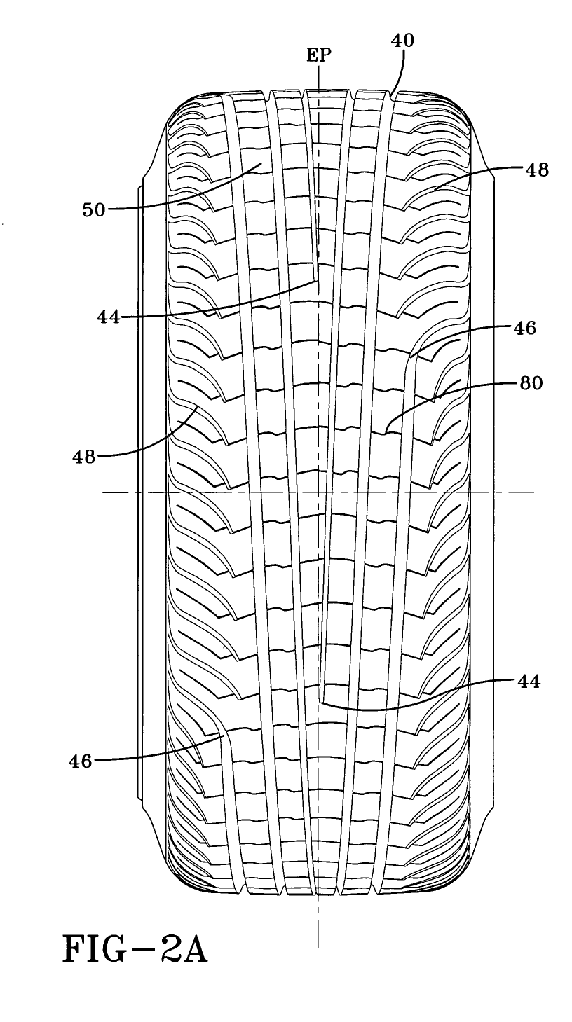

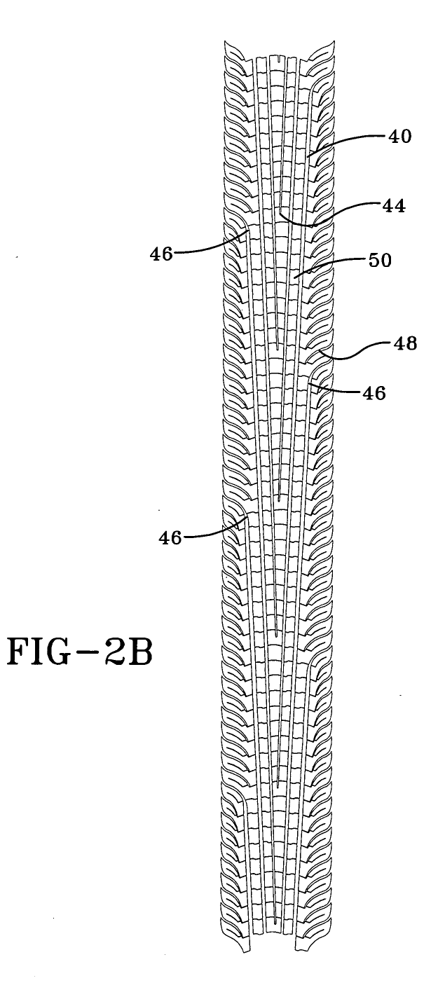

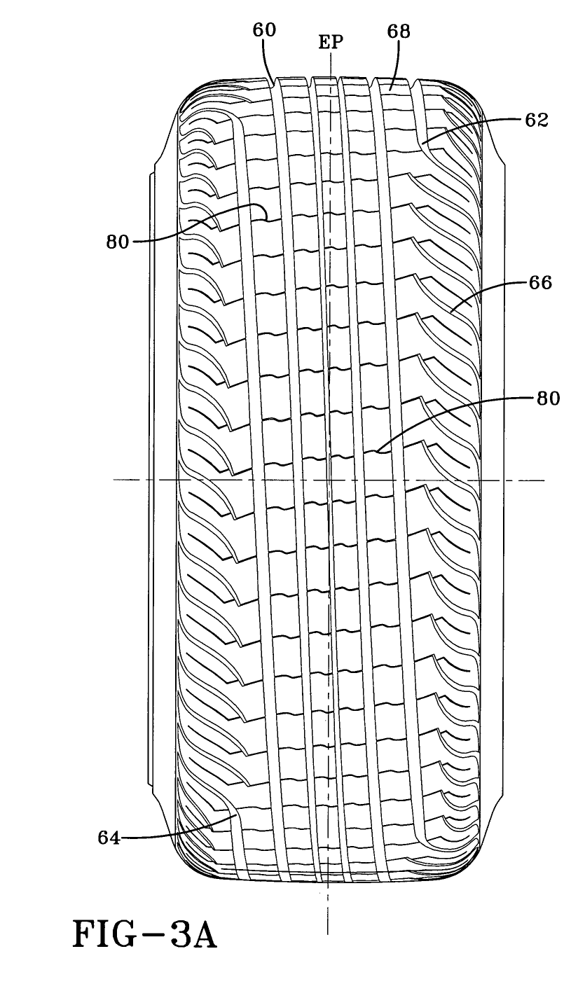

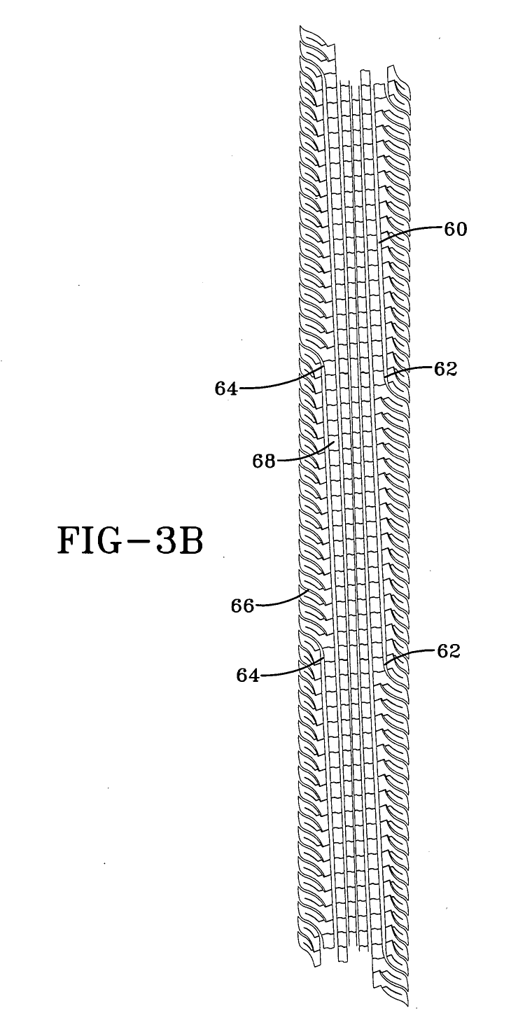

In the second tread half is at least one circumferentially extending groove 28 having a spiral configuration that winds along the tread surface. Relative to the equatorial plane of the tire, the spiral groove 28 is inclined at an angle β, relative to the equatorial plane, of not more than 30°. The spiral groove 28 has a pair of terminal ends 30, 32, see FIG. 1B. The terminal ends of the spiral groove 28 are laterally spaced from one another across the tread width. A terminal end 30, 32 of the groove is defined as such when it is a blind end (i.e. the groove terminates in tread rubber and is not connected to another groove) or connects to, or is coincident with, another groove wherein the other groove has a substantially different orientation from the first groove, i.e. the other groove has an inclination angle substantially greater than 30° (this type of terminal end is illustrated in FIGS. 2A-3B).

A first terminal end 30 for the spiral groove 28 is located near the tread edge. The terminal end 30 may be located at the tread edge or even in the tire shoulder. The terminal end is connected to a lateral groove 34, and coincident with the end of the lateral groove 34; the lateral groove 34 being one in a plurality of lateral grooves 34 located in the shoulder region of the particular tread half. The connection to the lateral groove 34 enables any water in the spiral groove 28 to be ejected from the side of the tire through the lateral groove 34. Preferably, a terminal end 30 of a spiral groove, when located in a shoulder region of the tread, is located within 20% of the tread width from the tread edge 12, most preferably, within 15% of the tread width from the tread edge; the tread width being calculated between the opposing tread edges 12, 14.

For the illustrated tire, a second terminal end 32 of the illustrated spiral groove 28 is located near the equatorial plane EP of the tire. When the terminal end of a spiral groove is located within the central region of the tire, i.e. the central fifty percent of the tread width, the terminal end is most preferably located at or spaced not more than 10%, most preferably not more than 5%, of the tread width from the equatorial plane EP of the tire; the 10% spacing being considered “near” the equatorial plane EP of the tire.

Additionally, the width of the spiral groove 28 may vary over the length of the groove 28. For the spiral groove 28 of FIGS. 1A and 1B, beginning at the terminal point 30 near the equatorial plane EP of the tire, the width of the groove gradually increases from a very narrow width, reaching a maximum width at the tread edge terminal point 28. The width of the groove 28 may vary from what is conventionally referred to as a sipe width, i.e. a width in the range from about 0.2% to 0.8% of the tread width, to any greater width. Thus, for the tread of FIGS. 1A and 1B, the spiral grooves 28 increase from a sipe to a wide groove as they travel across the tread.

The spiral groove 28 has a circumferential length between the terminal ends 30, 32 of at least 50% of the circumferential length of the tire, both length measurements being made on the outer tread surface of the tire and parallel to the equatorial plane EP. Preferably, the spiral groove 28 has a length of at least 75% of the circumferential length of the tire. In the illustrated tire, the spiral groove 28 has a length approximately 95% of the circumferential length of the tire and wraps about the tire tread just under one full revolution. In another desired configuration, the spiral groove 28 has a length of at least 100% of the circumferential length of the tire, the spiral groove 28 wrapping about the tread at least once. The wider the tire, and the greater the tread width for the spiral groove 28 to travel, the greater the wrapping of the groove 28 about the tire circumference.

The spiral groove 28 is distinct from the continuous circumferentially extending grooves 16, 18 as the continuous circumferentially extending grooves 16, 18 each form a ring around the outer circumference of the tire and do not have a stopping or starting point. The spiral grooves 28 are defined by laterally offset terminal points that create a spiral rib 36 that “moves” across the tread half. While the spiral grooves 28 of FIGS. 1A and 1B do not fully wrap about the tread circumference, the grooves 28 create a plurality of ribs 36 that fully wrap about the tread, and preferably the spiral ribs 36 generated have a length greater than the circumferential length of the tire, as measured parallel to the equatorial plane EP.

In the tread of FIGS. 2A and 2B, the tread is provided with six spiral grooves 40. Each spiral groove 40 has an inner terminal end 44 located near the equatorial plane EP of the tread with an outer terminal end 46 located near the tread edges with the outer terminal ends 46 merging into lateral grooves 48. The outer terminal points 46 of the spiral grooves 40 in each tread half are circumferentially offset from each other, creating in each tread half an offset mirror image of the other tread half. In these spiral grooves 40, the groove width gradually increases from the inner terminal point 44 to the outer terminal point 46. The spiral grooves 40 create a continuous spiral rib 50 extending from one tread edge to the tire equatorial plane, with the ribs merging together at the equatorial plane, effectively creating a continuous rib across the entire tread.

In the tread of FIGS. 3A and 3B, spiral grooves 60 extend from one terminal end 62 located in one tread half, near the tread shoulder, to a second terminal end 64 located in the other tread half, near the opposing tread shoulder, the spiral grooves 60 traversing the equatorial plane EP of the tire. The terminal ends 62, 64 are coincident with ends of lateral grooves 66 in the tread shoulders. Multiple continuous spiral ribs 68 that “travel” across the tread width are created by the grooves 60. In this embodiment, the width of the spiral grooves 60 varies, with the width decreasing in the central region of the tread, and having a minimum width at or near the equatorial plane and a maximum width at or near the groove ends 64, 66.

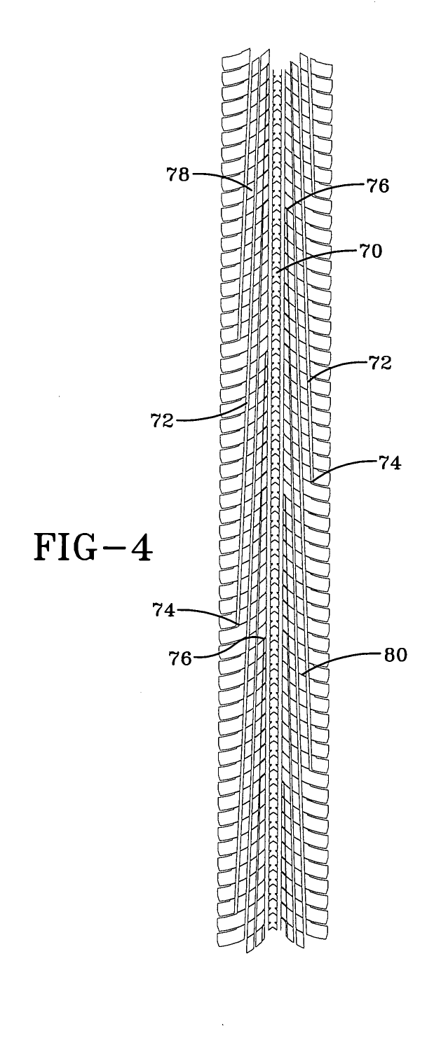

FIG. 4 illustrates another embodiment of a tread having spiral grooves. The tread has a central rib 70 located on the equatorial plane of the tread. In each tread half, on opposing sides of the central rib 70, are multiple spiral grooves 72. The spiral grooves 72 have a first terminal end 74 located near the tread shoulder and a second terminal end 76 located within the tread half, distanced from the equatorial plane. Similar to the other embodiments, the spiral grooves 72 create multiple continuous spiral ribs 78 that travel across the tread.

All of the illustrated spiral grooves are smooth sided spiral grooves; however, if desired the spiral groove may have a secondary zig-zag configuration as the spiral grooves wind across the tread surface. Also, while each illustrated tread has more than one spiral groove, the tread may be provided with only a single spiral groove extending from one tread edge to the other, the groove wrapping about the tire circumference multiple times. The number of spiral grooves in the tread will depend on the desired tire tread configuration; in the illustrated embodiments, the number of spiral grooves varies from a total of three to six grooves. Preferably, the number of spiral grooves is less than ten.

Each of the illustrated treads shows a plurality of sipes 80 in the tread. Any desired sipe configuration may be employed; the particular configuration selected being determined by the tire engineer to achieve the desired tire characteristics. In each illustrated embodiment, the sipes connect the adjacent wraps of the spiral grooves 28, 40, 60, 70.

Also, while not illustrated, if desired for additional water or noise evacuation in the tread, the tread may include any variation of lateral grooves extending between the adjacent wraps of the spiral grooves 28, 40, 60, 70. Such a tread can be easily visualized by replacing any of the sipes 80 in the illustrated embodiments with lateral grooves.

What is claimed is:

1. A pneumatic tire, the tire having a tread, a radially outermost surface of the tread defining a circumferential length of the tire, the tread comprising at least one circumferentially extending groove, the groove having a pair of terminal ends, the tire characterized by the at least one circumferentially extending groove having a spiral configuration across the tread surface wherein the length of the at least one spiral groove between the terminal ends is greater than 50% of the circumferential length of the tire.

2. The tire of claim 1 wherein the at least one spiral groove is inclined at an angle of not more than 30° relative to the equatorial plane of the tire.

3. The tire of claim 1 wherein both terminal ends of the at least one spiral groove are located in the same tread half.

4. The tire of claim 1, the tire tread having a pair of opposing tread edges, the tread having a defined width between the tread edges, wherein one terminal end of the at least one spiral groove is located within 20% of the tread width from a tread edge.

5. The tire of claim 1 wherein one terminal end of the at least one spiral groove is at or near the equatorial plane of the tire.

6. The tire of claim 1, wherein the tread has not more than ten spiral grooves therein.

7. The tire of claim 1 wherein the at least one spiral groove traverses the equatorial plane of the tire.

8. The tire of claim 1, the tire tread further comprising a plurality of transverse grooves, wherein one terminal end of the at least one spiral groove is coincident with a transverse groove.

9. The tire of claim 1 wherein the width of the at least one spiral groove varies along the length of the groove.

10. The tire of claim 1 wherein one terminal end of the at least one spiral groove is a blind end in the tread.

11. The tire of claim 1 wherein the length of the at least one spiral groove between the terminal ends is greater than 75% of the circumferential length of the tire.

12. The tire of claim 1 wherein the length of the at least one spiral groove between the terminal ends is greater than the circumferential length of the tire.
